(19) United States
(12) Patent Application Publication
(10) Pub. No.: US 2009/0094114 A1
(43) Pub. Date: Apr. 9, 2009

(54) SYSTEMS AND METHODS FOR OPTIMIZED ADDRESSABLE ADVERTISING

(76) Inventors: Daniel J. Rice, Portland, OR (US); Lawrence J. Derany, Wellesley, MA (US)

Correspondence Address: BLACK LOWE & GRAHAM, PLLC, 701 FIFTH AVENUE, SUITE 4800, SEATTLE, WA, 98104, US

(21) Appl. No.: 12/243,713

(22) Filed: Oct. 1, 2008

Related U.S. Application Data
(60) Provisional application No. 60/977,289, filed on Oct. 3, 2007.

(51) Int. Cl. G06Q 30/00; G06Q 40/00

(52) U.S. Cl. 705/14; 705/37; 705/26

(57) ABSTRACT

The system and method includes, in one embodiment targeted micro-advertising that allows buyers and sellers of advertisements to be advantageously paired. The system allows for potential sellers of advertising space to post available times. Buyers then may view and purchase the list of available advertisement space. In some embodiments, buyers of advertising space may bid for the space which creates an auction. The auction creates a market for both available advertising opportunities and purchasers of the opportunities.

### PRIORITY CLAIM

This application claims the benefit of the filing date of U.S. Provisional Patent Application No. 60/977,289 filed on Oct. 3, 2007, which is herein incorporated by reference in its entirety.

### BACKGROUND OF THE INVENTION

The video advertising market is changing substantially due to the invention of new technology associated with video delivery. Now that service providers based on Direct Broadcast Satellite (DBS), Telcom Fiber Optic Networks (FTTx), Web Based Video commonly referred to as Internet Protocol Television (IPTV) and Cable Television (CATV) networks are offering video programming on a “demand basis” with devices such as personal and network based Digital Video Recorders (DVR) and Video On Demand (VOD) systems many customers now have the capability to skip or fast forward through commercials. This de-values the available commercial advertising opportunities (Avails) because the total actual audience impressions for the commercial are going down due to the consumer's ability to choose not to watch the advertising. The convenience of these new video delivery systems allows much easier consumer avoidance of advertising while also allowing consumers to pick from a much greater selection of video programming customized to their particular tastes as opposed to many viewers watching the traditional broadcast networks peaking at certain times of day and for “hot” linear programming. The availability of video content through VOD systems and from IP based internet networks on demand is also limiting the number of impressions for traditional advertising in broadcast video content. The ability to watch programming conveniently at any point in time after original broadcast also makes any pre-encoded or inserted advertising potentially inaccurate. For example, if an advertisement for a product or a special price was time limited and the commercial was viewed after the time limit expired, the viewing of the commercial could be misleading and of no value or even negative value to the advertiser. These market and technology changes are driving service providers whose goal it is to retain advertising sales, to find alternative methods such as, among others, internet delivered or advertising supported VOD, or increased targeting of advertising to increase the value of the viewer of the advertising and the value of the advertising to the viewer to compensate for the loss in total number of impressions. This targeting, known as narrowcasting, can deliver commercials broadly to a certain market segment based on for example, zip code or ad-zone. The internet advertising model is coming into maturity where the increased value of the ad impressions are based on targeting the advertising content dependant on criteria such as, among others, key words in searches, previous websites visited, websites that would attract certain demographics to increase the per impression value with the lower volume of impressions.

Small companies often do not have the financial means or the need to broadcast advertising to large audiences. Further, small companies currently do not have a cost effective way to micro-target local consumers. A method is needed to reach a targeted demographic of local customers who would be interested in a product or service of a smaller company and where the traditional video advertising model is priced for the total number of broad market impressions which is less relevant to this type of business. For example, a local auto shop would not want to advertise in a metropolitan area, but may only want to advertise in a three mile by three mile area.

Additionally, the business expenses for smaller local companies are not aligned with all the parties involved in advertising today. The business would need to hire ad agencies to design and create an advertising campaign, pay ad availability aggregators who sell the available opportunities to the agencies, and pay the owner of the available opportunities. All of these agencies create a less efficient system for smaller companies to achieve an effective return on investment for video advertising.

FIG. 1 shows the basic architecture 100 for advertising insertion today into analog television programming. The advertising is stored on an advertising server, and then converted to analog video format by a decoder. The broadcast linear programming is received over satellite or fiber optic network and converted to analog audio and video by the integrated receiver decoder and when the queue tone is detected by the Ad Switch the advertising content is inserted and played out until the advertising period is over, at which point it returns to the broadcast programming. This feed is then broadcast to a very wide audience through a satellite or terrestrial network serving millions of homes. The current advertising architecture does not allow addressable advertising based on end viewer demographics. Every viewer sees the same ad, and the ads cannot be targeted for particular demographics. When this broadcast television is displayed at a premises such as a health club or sports bar it does not allow all the premises owners to participate in the advertising value chain while their customers view the advertising. A premises can be considered any business or location where people are exposed to video programming when located in the premises whether they are physically on site at the location, or virtually present through a remote internet or telecommunications connection.

The digital television now being delivered by cable, telephone communications, and satellite operations has similar advertising insertion architecture 200 in use today as shown in FIG. 2. Several of the components are configured to handle the different digital format, but the process is essentially the same. When the digital queue tone is identified the digital advertising content is spliced into the stream and when the advertising period is over, the broadcast programming continues. This is then broadcast to a very wide audience through a satellite or terrestrial network serving millions of homes.

### SUMMARY OF THE INVENTION

The system and method includes, in one embodiment, targeted micro-advertising that allows buyers and sellers of advertisements to be advantageously paired. The system allows for potential sellers of advertising space to post available times. Buyers then may view and purchase the list of available advertisement space. In some embodiments buyers of advertising space may bid for the space which creates an auction. The auction creates a market for both available advertising opportunities and purchasers of the opportunities. The buyer of advertising space has the ability to search for particular kinds of businesses and also in particular locations that would be most beneficial for the buyer and where the buyer will most likely have interested potential clientele. The buyer also has access to an advertising content authoring system, which allows the buyer to prepare advertisements without having to hire a consultant or an advertising executive. The seller of advertising has control over what is shown and when it is shown in their place of business. The advertisements can be shown over televisions, at a kiosk, or as overlays onto current programming. Businesses may also have a more informational kiosk, which contains additional advertising information. The system is run over a network using a plurality of servers. The servers at a central facility allow for buyers to find advertising space, run the auction and payment networks and the advertising authoring tools. At the point of advertising (the sellers place of business) a plurality of servers in communication with the central facility allow for the receipt and broadcast of content, tracking auditing data and further allows for account management.

### BRIEF DESCRIPTION OF THE DRAWINGS

The preferred and alternative embodiments of the present invention are described in detail below with reference to the following drawings.

FIG. 1 shows the basic architecture for a prior-art advertising insertion into analog television programming;

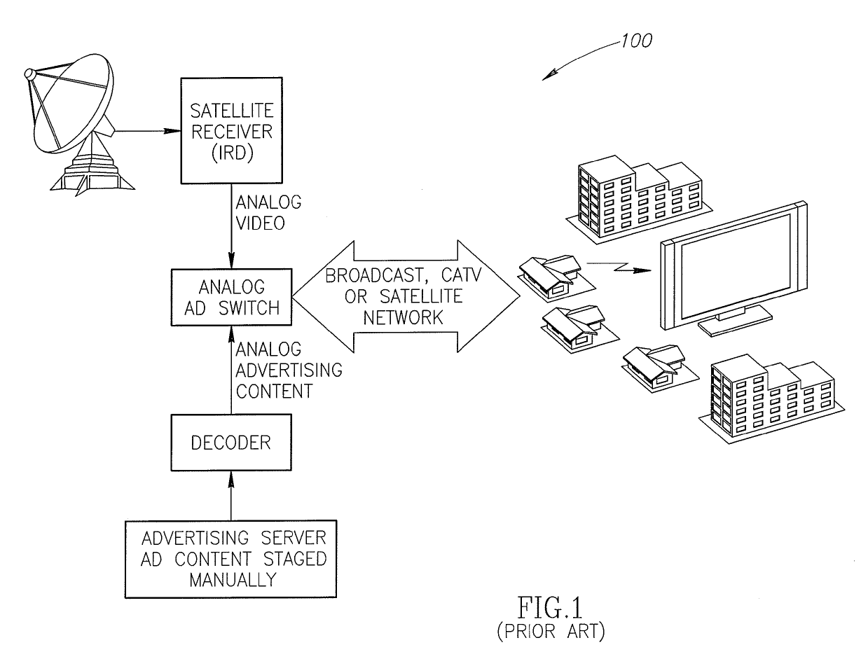

FIG. 2 shows the basic architecture for a prior-art advertising insertion into digital television programming;

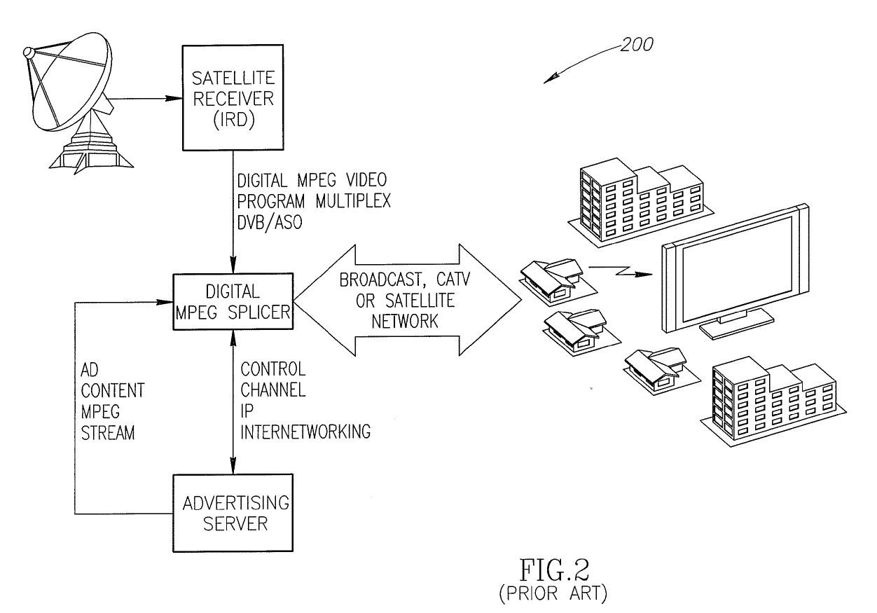

FIG. 3 shows the components of one embodiment of the system and architecture at a high level;

FIG. 4 shows the regional advertising content distribution center or the centralized advertising aggregation center system in one embodiment; and

FIG. 5 shows an example of the advertising system local premises architecture.

### DETAILED DESCRIPTION OF THE PREFERRED EMBODIMENT

What is disclosed is a system and process for substantially increasing the value of an impression, by targeting the advertising content to desirable viewers who would be generally interested in the advertising content, are in a situational position, such as a premises, where they cannot opt out of viewing the advertising, and the number of impressions in advertising can be managed locally to ensure it is effective. One embodiment of this invention also increases the value to the advertiser and the owner of the available advertising opportunities through several business processes where the number of impressions of the advertising content and the timeliness of the advertising delivery can be controlled with increased incentive and success. One of the keys to one embodiment of the disclosed invention is the attributes of the premises where the advertisement is played. For example, a health club is likely to have patrons who would be members of the ideal target market for sporting goods equipment, health and nutrition products, or a local personal trainer service. This process allows the premises owner to monetize the available impressions and obtain revenue for this resource: the captive audience in the health club. Similar to a CATV service provider who has available slots in broadcast programs which are sold to advertisers, the premises owner can provide slots available for viewing by its members or customers. This invention allows the premises owner to provide available slots through several methods and to be compensated for displaying the advertising. In one embodiment and by way of example, a local sporting goods retailer has an abundance of yoga supplies, and contracts with the local health club to run ads for the purchase of yoga supplies in the club. The owner of the store may pay extra for the ad to be run before and after the club's yoga classes. The premises owner then controls when the ad is activated and the system can record audit details for the store owner when the ad was run and how many yoga students saw the advertisement.

One embodiment of this invention also discloses an auction-based system with tools allowing direct and efficient commerce between those with advertising opportunities or avails and those who need to advertise their products or services.

The invention can be thought of as a 4 dimensional optimization process. The optimization may accomplish at least four goals: 1) Monetize and increase the available opportunities for advertising, creating a valuable resource for advertisers and monetizing a valuable asset for the premises owners. 2) Increase the number of impressions for the advertising by eliminating ad skipping and increasing the total number of available opportunities. 3) Increase the value of each single impression, by micro-targeting or assuring the relevance of the advertising is high for the people that view the advertising so that they are interested in the advertising content thus further ensuring the advertising is not skipped. 4) Increase the efficiency of the market place through direct transactions between advertisers and owners of Avails through online commerce engine and standard simple advertising content production tools.

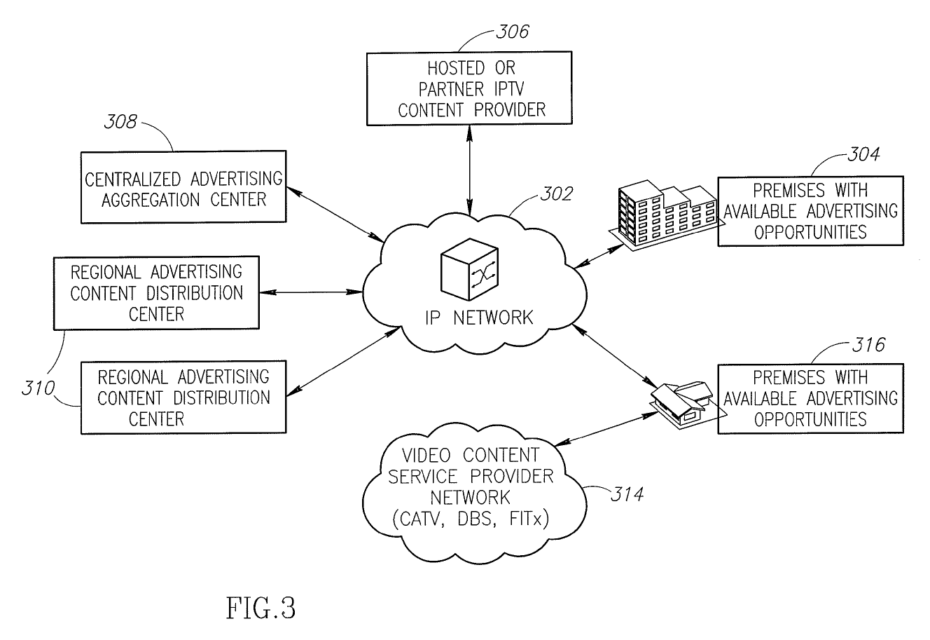

FIG. 3 shows the components of one embodiment of the system and architecture at a high level. The architecture allows for a centralized aggregation at an advertising content center 308 and also a distributed nature where the advertising content can be located in regional distribution centers 310. The value of distributing the advertising creation and content centers is to allow the system to scale in its distribution bandwidth and storage and to provide regional customization of tools such as local language support, and inventory management or local sales management. Distributing the system in such a manner can also increase availability and reliability. If one advertising distribution center 308 loses network connectivity or has a hardware failure, one of the other regional distribution centers 310 may support the customers while repair or maintenance is being performed. Through known techniques the centralized aggregation center 308 and the regional distribution centers 310 can synchronize, distribute, and replicate content as digital data. The main content delivered to the premises comes from a traditional service provider 314 such as CATV, DBS, or FTTx. Alternatively, the content could be delivered through an independent partner or hosted content channel 306 using IPTV content. Additional value is created for the advertiser when the system advantageously coordinates the independent content provider channel 306 and advertiser to ensure that both the independent content and advertising are of high interest to the viewer demographic at the premises.

The advertising, commerce systems, and advertising creation is accommodated over Internet Protocol (IP) networks 302, either privately or publicly managed. Broadband penetration in homes and businesses has now exceeded 50% in North America and is even higher in other geographies. The technology for these IP networks 302 is known such as inter alia DSL, FTTx, satellite, cable modems, or traditional telecommunications synchronous solutions such as a T1, ATM, or fiber based Ethernet solutions. The availability of an IP network 302 between advertising content distribution centers 308, 310 and premises locations 304, 316 is leveraged as part of this system. Commonly available technology is leveraged to secure and encrypt the advertising content, secure the aggregation and distribution centers 308 and the premises owner's internal IT network 302.

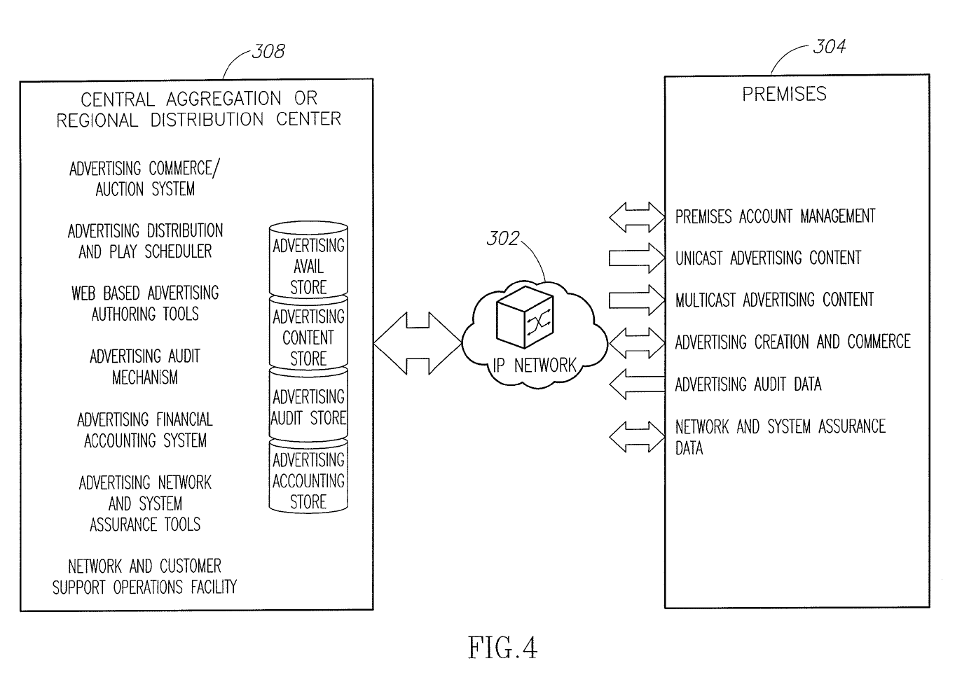

There are several components to the system that reside in the regional advertising content distribution center 310 or the centralized advertising aggregation center 308 as shown in FIG. 4. These can be deployed on one of several servers and include software and hardware systems working together to implement the business processes and transactions disclosed in one embodiment of this invention. The software may follow best practices based on for example, Services Oriented Architecture (SOA) techniques. Many of these processes run autonomously without user intervention or user interface, while several operate based on user input through a user interface mechanism. This user interface mechanism, for example, includes web browser based on HTTP protocols, API based on web service technology, command line interfaces, database configuration, and file based configuration. These processes include the following.

### Advertising Commerce/Auction System

In one embodiment, this system provides a means for premises owners and groups representing a group of premises owners, such as a franchise, to publish the availability of advertising opportunities (Avails). It also allows the business owners who want to purchase some advertising opportunities to do so. The opportunities made available to buyers can be a subset of the total Avails for a single premises owner, the total Avails for a single premises owner, or an aggregated set of Avails comprising multiple premises owners. The information about available opportunities is saved to the advertising Avail store database. The available advertising opportunities are presented with a set of attributes including inter alia: premises information, for example, name and contact info, and short description of business: sports bar catering to local college students. Geographic locations, for example, zip code, and/or street address. Length of opportunity in time, for example, a 10 second, or a 30 second spot consistent with advertising authoring tools. Time of day, for example, from 9 am to 11 am when soccer mom's are in a health club after getting kids off to school, or from 5 pm to 9 pm when younger professionals are in a health club. Type of content for opportunities, for example, audio, or video compatible with formats available through advertising authoring tools. Number of opportunities available for each type and length per time period, for example, 100 30 second Avails per day. Viewer interest(s) type information, for example, pre-defined categories such as health and nutrition, sporting goods, fitness, family, cooking, do-it-yourself, etc. May include categories and sub-categories. One of several price per impression options, for example, auction with a reserved minimum, auction with no minimum, fixed price, price based on time of day, price based on length of ad, volume discount schedule. The rate may change based on industry ratings of the linear or on-demand content which was playing before and after the advertising content, for example, based on Nielsen ratings.

These attributes are available through a search system to allow advertisers to find the right target opportunities including aggregating similar demographic premises. The advertising buyer has the choice of bidding for the available impression thereby establishing market pricing, or purchasing the impressions based on pricing and structure offered.

Alternatively an advertising buyer provides the relevant information above including the price they can pay for the impressions and the system will automatically filter the set of premises owners and make the offer to them directly and respond to the buyer when or if impressions are available and the details. Premises owners may opt out of offers for certain categories of content or specific advertisers as part of the auction or commerce engine workflow.

In the process of posting availability and bidding for spots, the accounts for each supplier of available spots and purchaser of available spots are created in the advertising accounting database.

### Web Based Advertising Authoring Tools

Since many small companies may not be able to afford some professionally developed audio and video advertising content, authoring tools are made available that allow things like simple text displays, audio based on common formats, or video based on common formats. For companies that develop external advertising content based on industry standard formats, these tools can be used to publish the content to the advertising content store database where it goes through a validation and quality assurance process. These tools ensure that the advertising content is compatible with the distribution network and the premises architecture for displaying the advertising content.

These tools enable on-demand real time authoring of advertising content at the local premises. For example, if a restaurant bar wants to advertise happy hour specials on appetizers for a short period of time, this can be published and delivered to the display easily and in real time. In this example, the advertisement may be audited and the transaction may be charged as the buyer and seller with the same account. See business process below. This may be thought of as a novel implementation of an audio/video “PA” system.

The authoring system can also be used to provide “telescoping” world wide web url(s) to e-commerce systems that can be embedded in the advertising content or made available in an interactive, Internet connected “kiosk” where the adds can be displayed or more information such as “long form” video advertisement or text and graphics can be found and coupons or other offers can be printed or emailed to the ad viewer. The long form video advertisements can also be distributed from the distribution center 308.

Advertising content may include inter alia advertising for products or services, short form or long form training materials, political advertisements, or sponsored public service announcements.

### Advertising and Distribution Play Scheduler

An advertising and distribution play scheduler delivers the advertising content to the local premises architecture. Once the commerce/auction system workflows result in the advertising transaction and the advertising content has been published to the advertising content store, the content is distributed with the schedule to the local premises architecture for all the relevant premises. This content and its schedule are then cached locally at the premises for play out. The content is distributed via a unicast or multi-cast means to all the authorized premises. The distribution of the content must occur before the content is scheduled to play out at the local premises. If insufficient storage exits to cache at the local premises, the advertising content may be streamed from the advertising distribution center through the premises architecture advertising system directly to the advertising system display controller. The access to the local premises architecture is secured through authorization and authentication to prevent unauthorized content to be delivered to the local premises.

In addition to a prior scheduling of advertisement, the system also allows for ad-hoc ad play out, triggered manually. For example, an ad could be triggered manually based on the number of people available for viewing the ad. This ad-hoc ad feature will be useful for the local premises to advertise its own products or services.

### Advertising Audit Mechanism

An advertising audit mechanism tracks each transaction that occurs in the system and maintains a correlation id to allow reconciliation of detailed transactions. The advertising audit store database keeps track of all these transactions both scheduled and ad-hoc. The correlation id and method of communicating all transactions is performed based on best practice messaging and accounting technologies such as IPDR with specialized schema associated with this invention or one of several event messaging protocols. The types of transactions stored for audit include various points throughout the system and process. These can then provide detailed reports to advertising transaction parties to validate that the transaction was completed, the advertising content was published, distributed, and displayed. When integrated with other onsite systems that record the number of viewers on the premises, an exact number of viewers can be audited. Any errors or failures to meet the number of impressions can be credited or payment invoice generated based on actual number of impressions post play out. This database can also be used to troubleshoot failures to complete all transactions. These transactions include inter alia: advertising commerce complete; advertising content publish complete; advertising distributed validation; advertising local cache validation; advertising display times; total advertising display time; where available total number of viewers; telescoping request initiated; e-commerce transaction completed from telescoping; advertising incomplete play out time; unique identifiers for premises and advertising content and queue trigger; error messages for each process when they occur; and time stamps and status for each process when it occurs.

### Advertising Financial Accounting System

An advertising financial accounting system includes all of the transactions, which impact the billing and compensation. There are several parties, which may owe royalties or fees based on the configuration of the advertising transactions. There are several different kinds of business processes which can be used to help optimize the system in one of the four dimensions discussed above (Avails, impressions, value, and efficiency). Advertising transactions can have fixed and variable components to the transactions, such as: flat rate $/X impressions, different rates $/X impressions can be based on one or more of the following: demographics, geography, day/time of day/frequency/seasonal, type of business, and length of ad—optimizes value of “impression”; scope of purchase: single premise, group of premises, franchise chain, group of chains, hybrid groups—optimizes # of “impressions” and opportunities—scaling up a highly targeted offering at the scale expected by the advertising buyer is difficult without this mechanism; groups can be created based on selected rate criteria; the advertising system owner or operator can act as a broker taking a royalty percentage for each transaction, or a fixed fee for each transaction negotiated between premises owner and advertiser; the advertising system owner or operator can act as a service provider and can negotiate the transaction directly with advertiser and negotiate a royalty with the premises owner. An advertising system event sponsorship model includes single premise, group of premises, franchise chain, group of franchise chains, hybrid groups that want to sell availability for a particular broadcast event such as a particular sporting event at a sports bar. Enabling premises owner to cross promote using the advertising system includes the person at the premises can control the number and timing of impressions and the ad content manually depending on number of people at the premises, situational environment, or any of the factors above. The premises can be compensated, and the employee of the premises owner can be compensated.—optimizes number available advertising opportunities and the number of actual of “impressions” The audit system will track particular user accounts for manually triggered advertising displays thus allowing the compensation to be tailored to the individual who initiates the add. In combination with technology that enables time shifting of primary linear content such as a Digital Video Recorder (DVR)—periodically shifting away to advertising system content while buffering or not buffering the linear content. The royalties may increase based on the number of interactive telescoping queries to each advertisement and whether an online purchase was initiated from the premises—optimizes the value of the “impressions.” The business model may include the advertising system owner or operator pricing for the content distribution network including the cost for the IP network connectivity to the premises. In these cases the advertising system owner or operator negotiates the transaction with the advertiser and a royalty is paid to premises owner. The advertising system owner or operator acting as the selling agent for the advertisers will result in increased royalty to the advertising system owner or operator. A premises owner as selling agent through automated auction or in separate transaction independent of the advertising system owner or operator may result in different royalty fees to the advertising system owner or operator. The premises owner can use x % of total advertising system viewership (hours×eyeballs) content opportunity for local single shop advertising content royalty free. Chain franchise content can be distributed through the advertising system and the advertising system owner or operator receives a royalty. Premises owner can sign up as selling agent independent of automated advertising commerce portal and receive % of ad sales as commission. The IP network operator could be compensated for guaranteeing the quality of service (QoS) of the advertising system content when it is streamed live to the premises instead of being cached locally at the premises.

### Advertising Network and System Assurance Tools

Advertising network and system assurance tools can be used to assure that the network that distributes the advertising content is highly available, secure, and reliable. Also used to troubleshoot issues with the systems and support the operation of the systems. These systems also create reporting necessary for tracking transactions and business Service Level Agreement (SLA) metrics.

### Network and Customer Support Operations Facility

A network and customer support operations facility is an operations center where the transactions and networks can be monitored and where premises owners and advertisers can communicate with the advertising optimization system support staff.

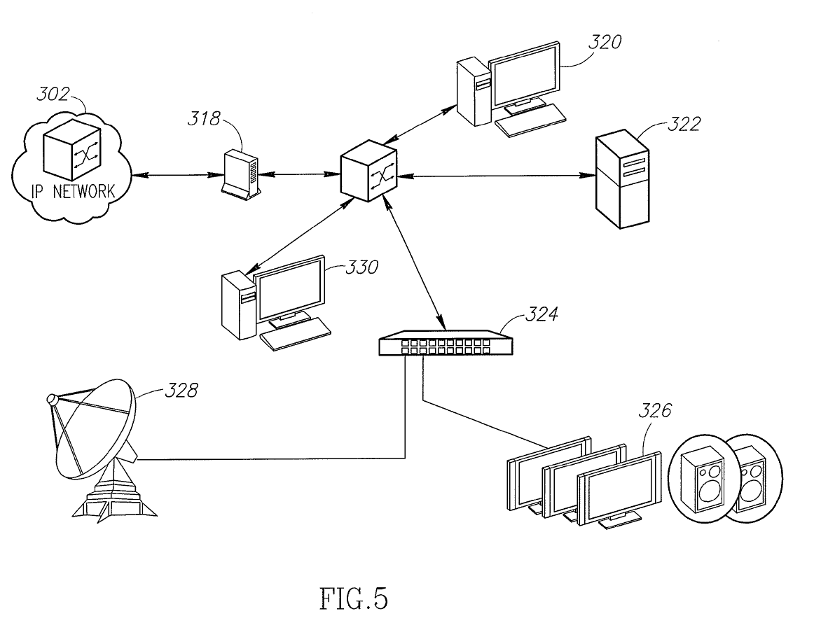

The advertising system local premises architecture is shown in FIG. 5. This system installed on the premises can be used to deliver the targeted advertising content and optimize the number of opportunities for advertising, the number of viewers of the advertising, and the value of the advertising viewers. The two interfaces external to the premises are the linear, On-Demand, or recorded programming content 328 made available to the users. For example, ESPN on the TV in a restaurant bar. The other input to the premises is the IP network 302 which provides the advertising content, IP video content from independent content providers, and other interactivity. In some cases, these could be a single network connection, for example a Broadband DSL, FTTx, satellite, or cable modem connection with IPTV video streaming of the programming content and also the delivery of the advertising content. There are several processes within the premises architecture as described below. These processes can run on a single server, a set of server computers, a dedicated appliance, or combination of these along with the advertising system display controller 324, which is similar to a video “set-top box.” These components can be networked together using common IP networking protocols and common routers or Ethernet switch technologies.

### Advertising System Administration 320

The advertising system administration 320 enables the following set of actions. Many of these can be performed through a web based interface which connects to a server in the regional data distribution center. Account management—setup account details. Local manual ad trigger—on site manual initiation of advertising opportunity, manual initiation can trigger next scheduled advertising content, or specific advertising content. System configuration—configuration of system preferences. Advertising authoring tools—tools to develop and publish advertising content, this includes tools for authoring local public announcement (PA) types of advertisements. Advertising commerce transactions—tools to negotiate and initiate advertising transactions.

### Premises Advertising System 322

A premises advertising system 322 is the main controller on the premises. This can be embedded with the system display controller or be deployed as a second physical system. This process performs the following functions. Advertising content cache distributed from regional content distribution center. Distribution of advertising content and interactive components to the optional kiosk and to the advertising system display controller. Management and scheduling of local premises advertising sessions based on local manual opportunities and schedule contract received from regional advertising distribution center. Generation of audit logs associated with each transaction and delivery of audit data to regional advertising distribution center.

### Advertising System Display Controller 324

The advertising system display controller 324 provides the mechanism for displaying the advertisement content along with the programming content. This device is similar to a video STB. In addition to audio processing and display technology, this device may have local hard disk, flash memory, or other non-volatile storage to buffer the main programming content or store the advertising content and store the audit logs similar to commonly used DVR technology. The advertising can be displayed in a variety of mechanisms, three primary mechanisms include: screen sharing, overlay and “change the channel” to advertising content. Screen sharing includes inserting content into the top and bottom of a 4:3 set when receiving high definition or the sides of a 16:9 set when receiving standard 4:3 content; periodically or constantly claim part of the screen for alternate content—reduction/alternate content space based on screen aspect ratio; and/or using space for static/dynamic/streaming advertising content. Overlay includes: logo overlay—top/bottom/corners; static/dynamic/streaming—similar to stock ticker; and an overlay would preferably have some transparency to all continued viewing of the main program content. “change the channel” to advertising content includes buffer programming content for the period of the ad on the system display controller 324, play out the ad, than start content again. Buffering may be triggered by ad attributes. In some cases a buffer may not be used and the linear content is displayed in progress after switching back from advertisement. Manual—“hit the button” functionality to immediately switch to the advertising content (business model requires—Audit the day/time/frequency). Detect pre-encoded commercial digital or analog queue tone or other metadata in programming content and automatically switch to insertion of advertising content. Return to programming content when pre-encoded commercials are finished, this techniques could include insertion into MPEG Transport stream directly, changing of channel or switching to MPEG audio and video program stream through internal STB software, or use of an IR blaster to simulate remote control type channel change. Media types among others that can be used for advertising content and passed through programming content. Video: analog, digital, HD digital, gaming, Lottery/Keno, VOD/PVR, pre-recorded content (DVD, HDDVD, Bluray DVD, future formats). Audio: analog, digital, satellite. An audit mechanism exists in display controller that provides details on validating advertising content display, time of display, error conditions, buffering times, content quality metrics, and network health metrics among other transactional data. Communication to the advertising system may be based on common TCP/IP protocols and programming protocols such as JAVA, XML, or IPDR. The display can be commonly used display devices such as, but not limited to, video monitors, televisions, or audio speakers and PA sound systems, streaming ticker text displays, Web Browser on monitors, and customer audio video solutions.

### Interactive Kiosk 330

An interactive kiosk 330 is an optional system that allows viewers who are in the premises to obtain further information or perform transactions based on the targeted advertising. This may include the following: telescoping to content on the IP network or longer form content in the advertising system during ad play-out by a remote control device. After viewing the ad follow-up on separate display kiosk including: advertising carousel with specific ad selection means; selection means where additional information or longer form ads can be obtained on advertised products and services; interactive product purchase e-commerce capabilities; audit capabilities to track when interactive information is obtained or when an e-commerce transaction takes place which may impact the business process for the transaction; communication means to obtain advertising content and interactivity elements from premises local advertising system architecture; print coupons or other promotional or informational materials; and email information to a viewer's email account. Allow viewer to indicate any specific type of advertisements they would like to see. For example, select a box that says I will be purchasing an SUV or am planning a beach vacation and would be interested in viewing special offers. An alternative type of kiosk 330 would be a mobile phone with SMS text message or email capability where a test message could be sent to number with a code shown in the advertisement for more information or an email to an email address shown in the advertisement.

While preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

The embodiments of the invention in which an exclusive property or privilege is: claimed are defined as follows:

1. A method for micro-advertising comprising:
searching for an advertising opportunity within the local community on an advertising website;
viewing a plurality of advertising opportunities based on at least one of time, cost and location;
selecting an advertising opportunity at an advertising location; and
purchasing the selected advertising opportunity using an internet commerce system.

2. Wherein the advertising location comprises a plurality of premises within a franchise.

3. The method of claim 1, further comprising authoring an ad campaign for use at the selected advertising location, wherein the authoring tools are accessible using the advertising website.

4. The method of claim 1, wherein purchasing the selected advertising opportunity further comprises bidding for the selected advertising opportunity in an auction.

5. The method of claim 1, wherein purchasing the selected advertising opportunity further comprises purchasing the opportunity at the advertising location.

6. The method of claim 1, wherein selecting an advertising opportunity further comprises selecting at least one of the display time for the advertisement and the quantity of times the advertisement will be displayed.

7. The method of claim 1, wherein selecting an advertising opportunity further comprises selecting a video advertising format including video screen margins for advertising display along at least one margin during a video feed to the center of a screen.

8. The method of claim 6, wherein the selection of the display time is executed manually at the time desired for the display.

9. The method of claim 1, further comprising receiving advertisement statistics from the advertisement location.

10. The method of claim 9, wherein the statistics include at least one of number of viewers, times the advertisement was displayed, and time of day advertisement was shown.

11. A method for matching an advertiser with an advertising location, comprising:
matching an advertiser and an advertising location using an advertising server connected to the internet, the advertising location selling advertising opportunities;
completing a transaction between a buyer and seller, such that an advertising opportunity is purchased;
providing a content authoring system that enables an advertiser to create advertisements; and
transmitting the created advertisement to the advertisement location over a data link.

12. The method of claim 11, farther comprising providing an interactive kiosk that allows a plurality of viewers to view additional information about an advertisement.

13. The method of claim 11, further comprising a means for receivers of the advertisement to purchase a product advertised at the advertising location.

14. The method of claim 11, further comprising integrating an advertisement within a content source.

15. The method of claim 13, wherein the content source is at least one of Cable TV, Satellite TV, Radio, and Recorded Media.

16. The method of claim 11, further comprising auditing an advertisement location to ensure advertisements were displayed as purchased.

17. The method of claim 11, further comprising providing the advertiser and the advertising location with statistics on how many viewers watch the advertisement.

18. The method of claim 11, further comprising providing an advertising system display control configured to display advertisement information at the advertisement location.

19. The method of claim 11, further comprising communicating with a premises advertising system configured to store advertisement information at the advertisement location.

20. The method of claim 11, further comprising auctioning advertisement opportunities to an advertiser.

21. The method of claim 11, wherein the advertisement is transmitted to a video display to be shown along at least one margin of the display.

22. A micro advertising system comprising:
a central aggregation and regional distribution center configured to contain at least one server containing information to enable the buying and selling of advertisement information; and
a premises server in data communication with the central aggregation and regional distribution center and configured to display advertising information at least one premises.

23. The system of claim 21, wherein the at least one premises comprises multiple related premises.

24. The system of claim 22, wherein the multiple related premises are at least part of a franchise.

25. The micro advertising system of claim 21, further comprising an interactive kiosk that allows a plurality of viewers to view additional information about an advertisement.

26. The micro advertising system of claim 21, further comprising an advertising system display control configured to display advertisement information at the advertisement location.

27. The system of claim 25, wherein the advertisement can be manually triggered at the advertisement location.

28. The micro advertising system of claim 21, further comprising a premises advertising system configured to store advertisement information at the advertisement location.

29. The micro advertising system of claim 21, further comprising a content authoring system that enables an advertiser to create advertisements.

30. The system of claim 28, wherein the content authoring system is at the premises of the displayed advertisement.
